(19) United States
(12) Patent Application Publication
(10) Pub. No.: US 2017/0187193 A1
(43) Pub. Date: Jun. 29, 2017

(54) CONTROL DEVICE

(71) Applicant: FUJI ELECTRIC CO., LTD., Kawasaki-shi (JP)

(72) Inventor: Kansuke FUJII, Machida (JP)

(73) Assignee: FUJI ELECTRIC CO., LTD., Kawasaki-shi (JP)

(21) Appl. No.: 15/338,522

(22) Filed: Oct. 31, 2016

(30) Foreign Application Priority Data
Dec. 25, 2015 (JP) 2015-254494

(51) Int. Cl. H02J 3/38

(52) U.S. Cl. CPC H02J 3/385

(57) ABSTRACT

A control device includes a power calculation unit that calculates output power of photovoltaic cells in a sweeping mode in which an output voltage of the photovoltaic cells is gradually varied from an open circuit voltage to a lower limit value of an MPPT (Maximum Power Point Tracking) control. The control device further includes a peak voltage holding unit that holds a peak voltage of the photovoltaic cells, the peak voltage corresponding to a maximum value of the calculated output power, and a mode switching unit that switches a power control mode from the sweeping mode to a global peak mode in which an output voltage of the photovoltaic cells is controlled so that it becomes closer to the held peak voltage when the maximum value of the output power calculated upon the varying of the output voltage of the photovoltaic cells is lower than a starting level of the MPPT control.

### CROSS-REFERENCE TO RELATED APPLICATIONS

This application is based upon and claims the benefit of priority of the prior Japanese Patent Application No. 2015-254494, filed on Dec. 25, 2015, the entire contents of which are incorporated herein by reference.

### FIELD

The present invention is related generally to a control device and particularly to a control device for a photovoltaic power conditioning system (PCS) including an AC (Alternating Current) invertor that converts DC (Direct Current) power output from photovoltaic cells into AC power.

### BACKGROUND

Power that photovoltaic cells can output varies depending upon the insolation on the photovoltaic cells, the temperature of the photovoltaic cells (panel temperature), etc. Accordingly, a photovoltaic power conditioning system controls the output power of photovoltaic cells so that the maximum power is output as much as possible in response to such changes in insolation and temperature.

Examples of a control method related to output power of photovoltaic cells include an MPPT (Maximum Power Point Tracking) control. In an MPPT control, a combination of the output voltage and the output current of photovoltaic cells, i.e., the operation point of the photovoltaic cells, is made to follow the maximum power point (optimum operation point) at which the photovoltaic cells generates the maximum power. In addition, examples of specific algorithms for realizing an MPPT control include a hill climbing method. In a hill climbing method, the following processes are repeated. Specifically, the output voltage and the output current of photovoltaic cells are measured, and the output power of the photovoltaic cells is calculated from the measured output voltage and output current. Then, the currently-calculated output power and the last-calculated output power are compared, and the output voltage of the photovoltaic cells is controlled so that the operation point of the photovoltaic cells becomes closer to the maximum power point.

As a related technique, the techniques disclosed by Japanese Patent No. 3732943 and Japanese Patent No. 5291896 are known.

Japanese Patent No. 3732943 for example discloses the following technique. A photovoltaic power generation device includes photovoltaic cells, a power conversion unit, a setting unit, a control unit and a resetting unit . The power conversion unit converts DC power output from the photovoltaic cells into AC power. The setting unit obtains the virtual optimum operation voltage and the control voltage range from the output voltage of the photovoltaic cells and a constant that is prescribed in accordance with the type of the photovoltaic cells, at the last minute the power conversion unit being activated. The setting unit sets the obtained virtual optimum operation voltage and control voltage range, setting a fixed voltage as the virtual optimum operation voltage, the control voltage range and the fixed voltage being for the photovoltaic cells. The control unit has first and second modes. In the first mode, the control unit activates the power conversion unit with the virtual optimum operation voltage as the target value of the output voltage, and thereafter in a stepwise manner changes the output voltage of the photovoltaic cells by a prescribed voltage change width in the direction in which the DC power output from the photovoltaic cells increases in the control voltage range. In the second mode, the control unit treats the output voltage of the photovoltaic cells as the fixed voltage when the DC power output from the photovoltaic cells is smaller than a prescribed power. The resetting unit increases at least one of the virtual optimum operation voltage and the control voltage range that are set for the photovoltaic cells, when the output power of the photovoltaic cells is not stable.

In addition, Japanese Patent No. 5291896, for example, discloses the following technique. A photovoltaic power conditioning system includes an obtainment unit, a determination unit, and an adjustment unit. The obtainment unit obtains the current-voltage characteristic of the photovoltaic cells from the low current state to the low voltage state. The determination unit determines as a voltage target value the voltage resulting in the maximum power in the current-voltage characteristic obtained by the obtainment unit. The adjustment unit adjusts the voltage of the photovoltaic cells so that the voltage becomes closer to the voltage target value determined by the determination unit. The obtainment unit obtains the current-voltage characteristic at time intervals in a range between one minute and three hours.

However, because the peak of the power generated by photovoltaic cells is elusive under, for example, low insolation, an MPPT control involves a risk that the operation point of photovoltaic cells will not be controlled for making it closer to the optimum operation point, reducing the power generation efficiency of the photovoltaic cells.

### SUMMARY

A control device according to an embodiment includes a power calculation unit, a peak voltage holding unit, and a mode switching unit. The power calculation unit calculates output power of photovoltaic cells in a sweeping mode. The sweeping mode is a power control mode for the photovoltaic cells in which an output voltage of the photovoltaic cells is gradually varied from an open circuit voltage to a lower limit value of an MPPT (Maximum Power Point Tracking) control. The peak voltage holding unit holds a peak voltage of the photovoltaic cells, the peak voltage corresponding to a maximum value of the calculated output power. The mode switching unit switches a power control mode for the photovoltaic cells from the sweeping mode to a global peak mode when the maximum value of the output power calculated upon the varying of the output voltage of the photovoltaic cells from the open circuit voltage to the lower limit value of the MPPT control is lower than a starting level of the MPPT control. The global peak mode is a power control mode for the photovoltaic cells in which an output voltage of the photovoltaic cells is controlled so that the output voltage becomes closer to the held peak voltage.

### BRIEF DESCRIPTION OF THE DRAWINGS

FIG. 1 illustrates a configuration example of a control device according to an embodiment and a photovoltaic power generation system including the control device;

FIG. 2 illustrates an example of state transition in the power control executed by the control device according to the embodiment;

FIG. 3 is a timing chart of a first example in the power control that is executed by the control device according to the embodiment;

FIG. 4 is a timing chart of a second example in the power control that is executed by the control device according to the embodiment; and

FIG. 5 is a timing chart of a third example in the power control that is executed by the control device according to the embodiment.

### DETAILED DESCRIPTION

Hereinafter, by referring to the drawings, detailed explanations will be given for the embodiments for implementing the invention.

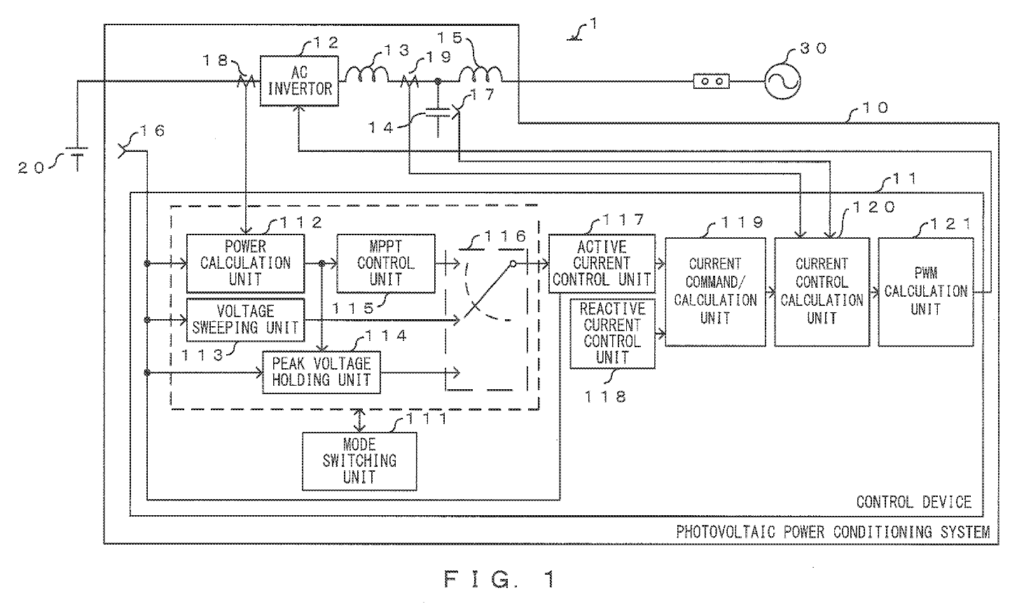

FIG. 1 illustrates a configuration example of a control device according to an embodiment and a photovoltaic power generation system including the control device. As illustrated in FIG. 1, a photovoltaic power generation system 1 includes a photovoltaic power conditioning system 10 and photovoltaic cells 20. The photovoltaic power conditioning system 10 includes a control device 11, an AC (Alternating Current) invertor 12, a first inductor 13, a capacitor 14, and a second inductor 15. In addition, the photovoltaic power conditioning system 10 further includes a first voltage sensor 16, a second voltage sensor 17, a first current sensor 18, and a second current sensor 19. The control device 11 is a configuration example of a control device according to the embodiment.

The photovoltaic cells 20 are connected to the AC invertor 12, and DC power output from the photovoltaic cells 20 is converted into AC power. AC power output from the AC invertor 12 is output to a power system 30 via the first inductor 13, the capacitor 14, and the second inductor 15. The first inductor 13, the capacitor 14, and the second inductor 15 constitute an LCL filter. The LCL filter is an example of a noise removal filter that removes a harmonic current contained in an AC current output to the power system 30.

The control device 11 controls the power output from the photovoltaic cells 20 so that the maximum power is output from the photovoltaic cells 20 as much as possible. Specifically, the control device 11 controls the current output from the AC invertor 12 so that the voltage output from the photovoltaic cells 20 becomes equal to the target voltage. In the explanations below, the power, voltage, and current output from the photovoltaic cells 20 may also be referred to as output power P_{PV}, output voltage V_{PV}, and output current I_{PV}, respectively, for the sake of convenience.

The control device 11 includes a mode switching unit 111, a power calculation unit 112, a voltage sweeping unit 113, a peak voltage holding unit 114, an MPPT control unit 115, and a target voltage switching unit 116. In addition, the control device 11 further includes an active current control unit 117, a reactive current control unit 118, a current command calculation unit 119, and a PWM (Pulse Width Modulation) calculation unit 121. The respective units in the control device 11 may be implemented by hardware such as a processor including a CPU (Central Processing Unit), an FPGA (Field Programmable Gate Array), and a PLD (Programmable Logic Device). Alternatively, the respective units in the control device 11 may be implemented by software such as a program that is executed by a computer.

In cooperation with the power calculation unit 112, the voltage sweeping unit 113, the peak voltage holding unit 114, the MPPT control unit 115, and the target voltage switching unit 116, the mode switching unit 111 switches the power control mode for the photovoltaic cells 20 that is executed via the AC invertor 12. The power control modes that are switched by the mode switching unit 111 include the standby mode, the sweeping mode, the global peak mode, the MPPT mode, and the holding mode.

The standby mode is a power control mode in which the photovoltaic power generation system 1 stands by to generate power.

The sweeping mode is a power control mode that gradually varies output voltage V_{PV} of the photovoltaic cells 20 from the open circuit voltage to the lower limit value of the MPPT control. In the explanations below, the target voltage of the photovoltaic cells 20 that gradually varies from the open circuit voltage to the lower limit value of the MPPT control in the sweeping mode, i.e., the target voltage in the sweeping mode, is also referred to as target voltage V_{PV*}_{_}_{SWEEP} for the sake of convenience.

The global peak mode is a power control mode that controls output voltage V_{PV} of the photovoltaic cells 20 at the peak voltage of the photovoltaic cells 20. The peak voltage of the photovoltaic cells 20 is output voltage V_{PV} of the photovoltaic cells 20 that corresponds to the maximum value of output power P_{VP} of the photovoltaic cells 20 calculated in the sweeping mode. The global peak mode is executed when the maximum value of output power P_{PV} calculated when output voltage V_{PV} of the photovoltaic cells 20 is varied from the open circuit voltage to the lower limit value of the MPPT control in the sweeping mode is lower than the starting level of the MPPT control. In the explanations below, the peak voltage of the photovoltaic cells 20 corresponding to the maximum value of output power P_{PV} of the photovoltaic cells 20 calculated in the sweeping mode, i.e., the target voltage in the global peak mode, is also referred to as target voltage V_{PV*}_{_}_{GPEAK} for the sake of convenience.

The MPPT mode is a power control mode that uses a hill climbing method to control the operation point of the photovoltaic cells 20 so that the operation point becomes closer to the maximum power point of the photovoltaic cells 20. The MPPT mode is executed when the maximum value of output power P_{PV} of the photovoltaic cells 20 calculated while output voltage V_{PV} of the photovoltaic cells 20 is varied from the open circuit voltage to the lower limit value of the MPPT control in the sweeping mode becomes equal to or higher than the starting level of the MPPT control. In addition, the MPPT mode is executed when output power P_{PV} of the photovoltaic cells calculated during the global peak mode becomes equal to or higher than the starting level of the MPPT control. In the explanations below, the target voltage of the photovoltaic cells 20 that is determined by the MPPT control using a hill climbing method, i.e., the target voltage in the MPPT mode, is also referred to as target voltage V_{PV*}_{_}_{MPPT} for the sake of convenience.

The holding mode is a power control mode in which, when output power P_{PV} of the photovoltaic cells 20 calculated during the MPPT mode becomes lower than the halting level of the MPPT control, output voltage V_{PV} of the photovoltaic cells 20 is held as output voltage V_{PV} at the point in time when output power P_{PV} became lower than the halting level of the MPPT control.

When a particular power control mode is set by an operation of the mode switching unit 111, the target voltage of the photovoltaic cells 20 in the set particular power control mode is input to the active current control unit 117. The active current control unit 117 obtains an active current command value from the input target voltage and output voltage V_{PV} of the photovoltaic cells 20 measured by the first voltage sensor 16. In addition, the reactive current control unit 118 obtains a reactive current command value for detecting the isolated operation state of the photovoltaic power generation system 1 and for maintaining the voltage of the power system 30. The obtained active current command value and reactive current command value are output to the current command calculation unit 119. The current command calculation unit 119 calculates an AC current command based on the input active current command value and reactive current command value, and outputs the calculated AC current command to a current control calculation unit 120.

The current control calculation unit 120 calculates a voltage command value of the AC invertor 12 on the basis of the input AC current command, the output voltage from the AC invertor 12 measured by the second voltage sensor 17, and the output current from the AC invertor 12 measured by the second current sensor 19. The calculated voltage command value is output to the PWM calculation unit 121. In accordance with the input voltage command value, the PWM calculation unit 121 calculates a gate pulse of a switching element (not shown) included in the AC invertor 12. Then, the PWM calculation unit 121 outputs the calculated gate pulse to the AC invertor 12. With the AC invertor 12 operating in accordance with the input gate pulse, output voltage V_{PV} of the photovoltaic cells 20 is controlled so that it becomes the target voltage in the set particular power control mode, and the maximum power is output from the photovoltaic cells 20 as much as possible.

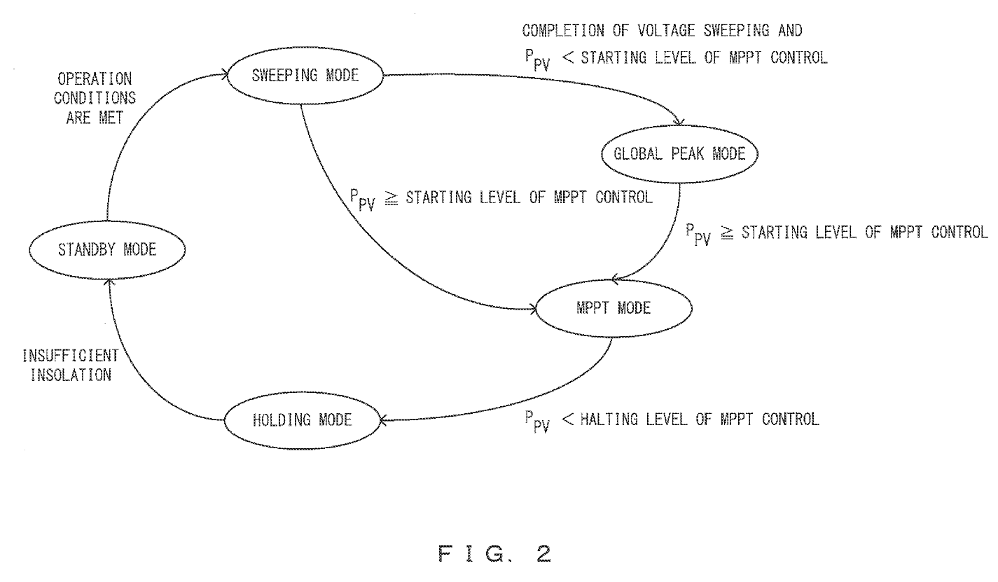

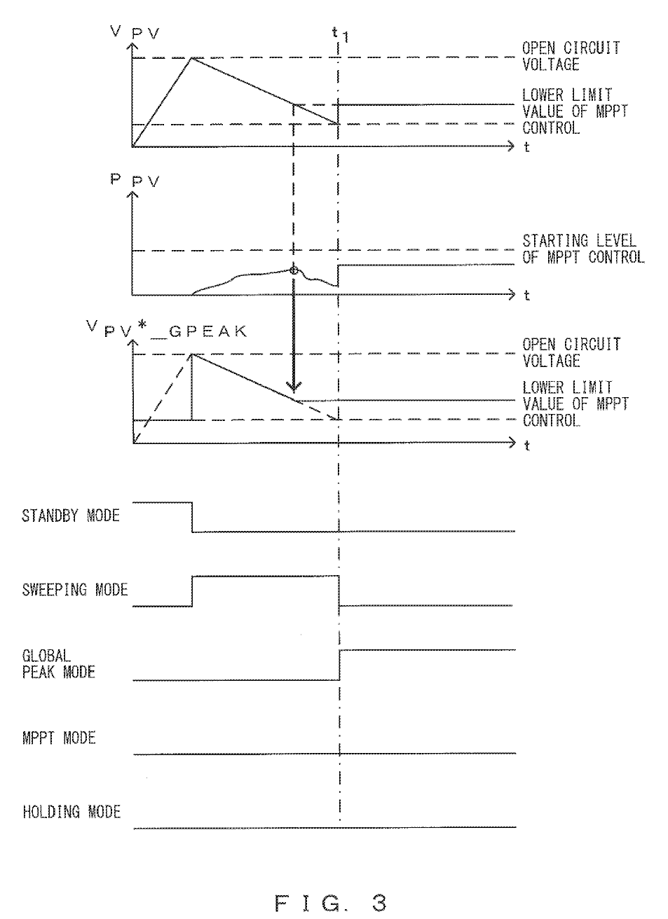

By referring to FIG. 2 through FIG. 5, explanations will be given for an example of power control for the photovoltaic cells 20, which is executed by the control device 11 of the embodiment via the AC invertor 12. FIG. 2 illustrates an example of state transition in the power control executed by the control device according to the embodiment. FIG. 3 through FIG. 5 are timing charts of the first through third examples in the power control that is executed by the control device according to the embodiment.

<Standby Mode>

With the photovoltaic power conditioning system 10 turned on by the operator of the photovoltaic power generation system 1, the power control mode enters the standby mode. In the standby mode, the mode switching unit 111 confirms that the respective units included in the photovoltaic power conditioning system 10, the photovoltaic cells 20, and the power system 30 involve no abnormality. Also, the mode switching unit 111 confirms that output voltage V_{PV} of the photovoltaic cells 20 measured by the first voltage sensor 16 is equal to or higher than a prescribed voltage value that makes the photovoltaic cells 20 start generating power. As illustrated in FIG. 2, when the operating conditions for the photovoltaic power generation system 1 are met after the above confirmation, the mode switching unit 111 switches the power control mode from the standby mode to the sweeping mode. For example, the mode switching unit 111 operates the target voltage switching unit 116 so that the voltage sweeping unit 113 is connected to the active current control unit 117.

Note that whether or not the respective units included in the photovoltaic power conditioning system 10, the photovoltaic cells 20, and the power system 30 involve abnormality may be monitored in a power control mode other than the standby mode. Further, although it is not illustrated in FIG. 2, when abnormality is confirmed in a mode other than the standby mode, the power control mode may be switched to the standby mode from that mode.

<Sweeping Mode>

Output voltage V_{PV} of the photovoltaic cells measured by the first voltage sensor 16 is input to the voltage sweeping unit 113. In the sweeping mode, the voltage sweeping unit 113 monitors input output voltage V_{PV}, and gradually varies target voltage V_{PV*}_{_}_{SWEEP} from the open circuit voltage to the lower limit value of the MPPT control. Note in the explanations below that a process of gradually varying target voltage V_{PV*}_{_}_{SWEEP} in the sweeping mode from the open circuit voltage to the lower limit value of the MPPT control may be referred to as voltage sweeping.

Target voltage V_{PV*}_{_}_{SWEEP} output from the voltage sweeping unit 113 is input to the active current control unit 117 via the target voltage switching unit 116. The AC invertor 12 is activated and operates so that output voltage V_{PV} of the photovoltaic cells 20 varies from the open circuit voltage to the lower limit value of the MPPT control in accordance with target voltage V_{PV*}_{_}_{SWEEP} input to the active current control unit 117.

The power calculation unit 112 sequentially (at prescribed intervals, for example) calculates output power P_{PV} of the photovoltaic cells 20 from output voltage V_{PV} measured by the first voltage sensor 16 and output current I_{PV} measured by the first current sensor 18. The power calculation unit 112 outputs calculated output power P_{PV} to the peak voltage holding unit 114 and the MPPT control unit 115.

The peak voltage holding unit 114 holds the lower limit value of the MPPT control as the initial value of target voltage V_{PV*}_{_}_{GPEAK}. The lower limit value of the MPPT control is the lower limit voltage value of the photovoltaic cells 20 in the control range of the MPPT control. In addition, the peak voltage holding unit 114 holds the operation starting level of the photovoltaic cells 20 as the initial value of output power P_{PV} of the photovoltaic cells 20. The operation starting level of the photovoltaic cells 20 is the lower limit power value that makes the photovoltaic cells 20 start generating power.

Output voltage V_{PV} of the photovoltaic cells 20 measured by the first voltage sensor 16 and output power P_{PV} of the photovoltaic cells 20 calculated by the power calculation unit 112 are input to the peak voltage holding unit 114. When current output power P_{PV} that has been input is greater than output power P_{PV} that is being held, the peak voltage holding unit 114 holds, as new target voltage V_{PV*}_{_}_{GPEAK}, output voltage V_{PV} of the photovoltaic cells 20 corresponding to current output power P_{PV}. In addition, the peak voltage holding unit 114 updates current output power P_{PV} as output power P_{PV} that is to be held newly. By repeating the above processes during the sweeping mode, the peak voltage holding unit 114 holds output voltage V_{PV} of the photovoltaic cells 20 corresponding to the maximum value of output power P_{PV} of the photovoltaic cells 20 calculated by the power calculation unit 112, i.e., the peak voltage, as target voltage V_{PV*}_{_}_{GPEAK}.

FIG. 3 illustrates an example, as a first example, of a timing chart for a case where the maximum value of output power P_{PV} of the photovoltaic cells 20 is lower than the starting level of the MPPT control when output voltage V_{PV} of the photovoltaic cells 20 has varied to the lower limit value of the MPPT control from the open circuit voltage in the sweeping mode. The starting level of the MPPT control is the lower limit power value of the photovoltaic cells 20 with which the MPPT control starts, and is set in advance. Cases such as in the first example can occur, for example, under low insolation.

At time t₁, the mode switching unit 111 confirms that the voltage sweeping has been completed by the voltage sweeping unit 113. In addition, the mode switching unit 111 confirms that the maximum value of output power P_{PV} held by the peak voltage holding unit 114 is lower than the starting level of the MPPT control. As illustrated in FIG. 2 and FIG. 3, confirming the above situation, the mode switching unit 111 switches the power control mode from the sweeping mode to the global peak mode. For example, the mode switching unit 111 operates the target voltage switching unit 116 so that the peak voltage holding unit 114 is connected to the active current control unit 117.

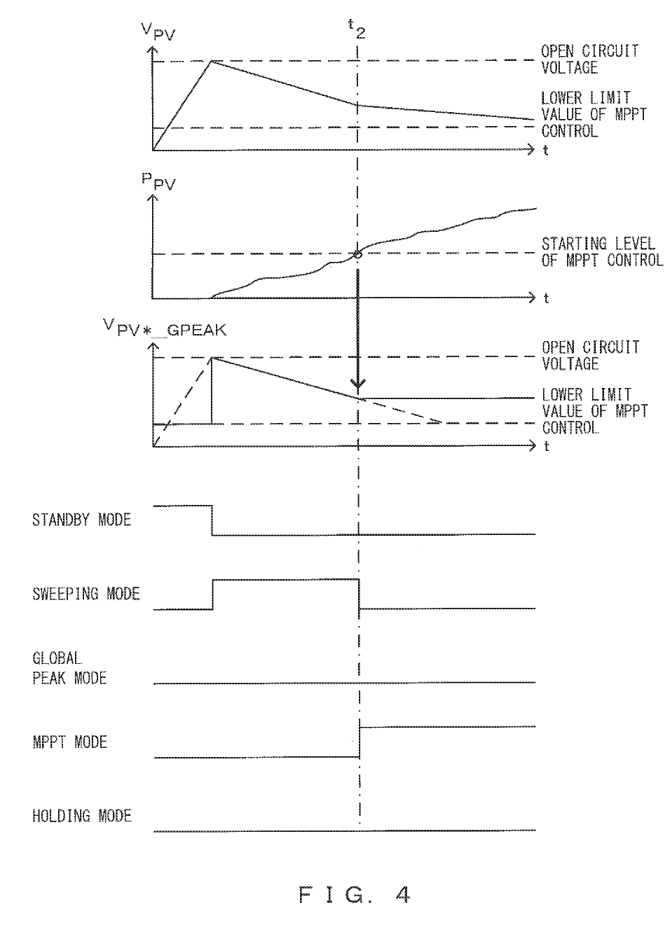

FIG. 4 illustrates an example, as a second example, of a timing chart for a case where the maximum value of output power P_{PV} of the photovoltaic cells 20 becomes equal to or higher than the starting level of the MPPT control while output voltage V_{PV} of the photovoltaic cells 20 varies from the open circuit voltage to the lower limit value of the MPPT control in the sweeping mode. Cases such as in the second example can occur, for example, under high insolation.

At time t₂, the mode switching unit 111 confirms that the maximum value of output power P_{PV} held by the peak voltage holding unit 114 becomes equal to or higher than the starting level of the MPPT control during the voltage sweeping executed by the voltage sweeping unit 113. As illustrated in FIG. 2 and FIG. 4, upon the above confirmation, the mode switching unit 111 switches the power control mode from the sweeping mode to the MPPT mode. For example, the mode switching unit 111 operates the target voltage switching unit 116 so that the MPPT control unit 115 is connected to the active current control unit 117.

<Global Peak Mode>

When the power control mode has shifted to the global peak mode, target voltage V_{PV*}_{_}_{GPEAK} output from the peak voltage holding unit 114 is input to the active current control unit 117 via the target voltage switching unit 116. As illustrated in the portions after time t₁ in FIG. 3, output voltage V_{PV} of the photovoltaic cells 20 is controlled via the AC invertor 12 so that it becomes equal to target voltage V_{PV*}_{_}_{GPEAK} held and output by the peak voltage holding unit 114.

In Japanese Patent No. 3732943, for example, the output voltage of the photovoltaic cells is a fixed voltage when DC power output from the photovoltaic cells is smaller than a prescribed power. However, the actual state of photovoltaic cells that can influence the power generation efficiency of the photovoltaic cells, such as the temperature of the photovoltaic cells, varies depending upon season and weather. Accordingly, when the output voltage of photovoltaic cells is a fixed voltage regardless of the actual state of the photovoltaic cells, the power generation efficiency of the photovoltaic cells may deteriorate. By contrast, as described above, in the control device according to the embodiment, the output voltage (actual measured value) of the photovoltaic cells of a case when the output power of the photovoltaic cells becomes the maximum value in the voltage sweeping is set as the target voltage. In other words, the target voltage used in the control device according to the embodiment reflects the actual state of the photovoltaic cells. Thus, according to the control device of the embodiment, the output power of the photovoltaic cells can be controlled so that the maximum power in accordance with insolation is output as much as possible, for example, under low insolation regardless of whether or not the panel temperature is different from the reference temperature.

In addition, in Japanese Patent No. 5291896 for example, the voltage resulting in the maximum power in the current-voltage characteristic obtained at time intervals in a range between one minute and three hours is determined as the voltage target value. However, a high frequency of obtaining the current-voltage characteristic leads to more power losses caused by the obtainment. In addition, a high frequency of obtaining the current-voltage characteristic involves a risk that the power pulsation accompanying the obtainment will deteriorate the power system in large-scale power generation facilities such as a mega solar system, etc. By contrast, as described above, in the control device according to the embodiment, the voltage sweep is merely executed when the operating conditions for the photovoltaic power generation system are met during the standby mode. Thus, the control device according to the embodiment can reduce opportunity losses of power generation and the deterioration of the power system that is caused by the obtainment of the target voltage.

Next, the mode switching unit 111 switches the power control mode when output power P_{PV} of the photovoltaic cells 20 calculated by the power calculation unit 112 during the global peak mode becomes equal to or higher than the starting level of the MPPT control. Specifically, the mode switching unit 111 switches the power control mode from the global peak mode to the MPPT mode as illustrated in FIG. 2. For example, the mode switching unit 111 operates the target voltage switching unit 116 so that the MPPT control unit 115 is connected to the active current control unit 117. Cases where output power P_{PV} of the photovoltaic cells 20 becomes equal to or higher than the starting level of the MPPT control during the global peak mode occur when an increase in the insolation caused by, for example, a temporal change from morning to daytime, recovery from bad weather, etc., increases output current I_{PV} of the photovoltaic cells 20.

As described above, the control device of the embodiment can swiftly shift the power control for the photovoltaic cells from power control executed with a prescribed target voltage under low insolation to MPPT control executed by using a hill climbing method under high insolation. Accordingly, the control device of the embodiment can control the output power of the photovoltaic cells so that the maximum power is output as much as possible in response to, for example, changes in time or weather during a day.

<MPPT Mode>

When the power control mode has shifted to the MPPT mode, the MPPT control unit 115 calculates, by using a hill climbing method, target voltage V_{PV*}_{_}_{MPPT} from output power P_{PV} calculated by the power calculation unit 112. The MPPT control unit 115 outputs calculated target voltage V_{PV*}_{_}_{MPPT} to the active current control unit 117 via the target voltage switching unit 116.

Output voltage V_{PV} of the photovoltaic cells 20 is controlled so that it becomes equal to target voltage V_{PV*}_{_}_{MPPT}. In the portions after time t₂ in FIG. 4, the process in which the MPPT control using a hill climbing method gradually lowers output voltage V_{PV} of the photovoltaic cells 20 in response to an increase in output power P_{PV} of the photovoltaic cells 20 is illustrated.

Next, the mode switching unit 111 switches the power control mode from the MPPT mode to the holding mode when output power P_{PV} of the photovoltaic cells 20 calculated by the power calculation unit 112 during the MPPT mode becomes lower than the halting level of the MPPT control as illustrated in FIG. 2. For example, the mode switching unit 111 operates the target voltage switching unit 116 so that the MPPT control unit 115 remains connected to the active current control unit 117. In addition, the mode switching unit 111 instructs the MPPT control unit 115 to hold, as target voltage V_{PV*}_{_}_{MPPT}, output voltage V_{PV} at the point in time when it became lower than the halting level of the MPPT control. The halting level of the MPPT control is a lower limit value of the power of the photovoltaic cells 20 that halts the MPPT control, and is set in advance.

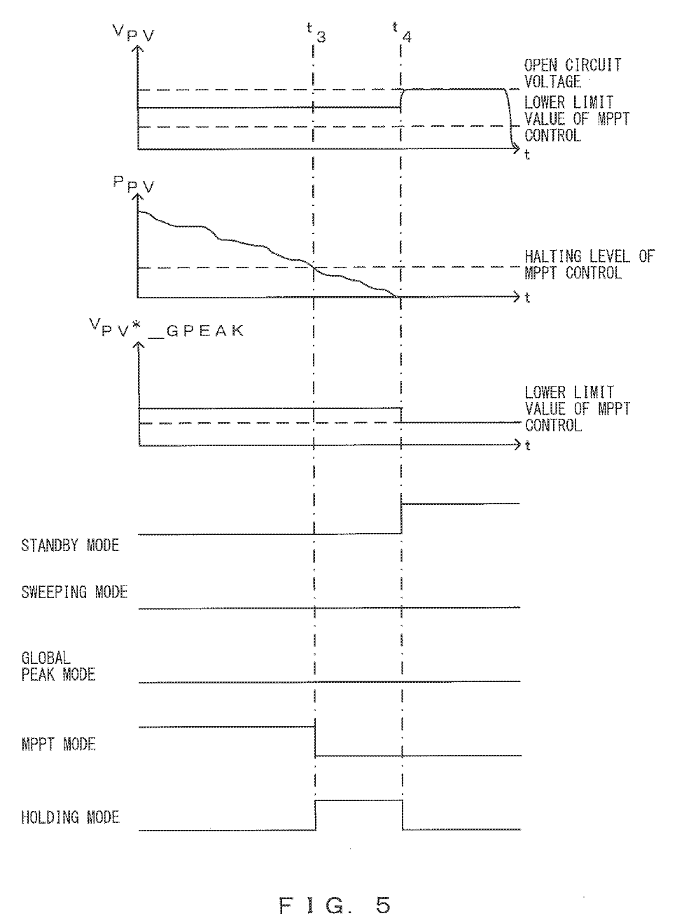

FIG. 5 illustrates an example, as a third example, of a timing chart for a case where output power P_{PV} of the photovoltaic cells 20 calculated by the power calculation unit 112 during the MPPT mode became lower than the halting level of the MPPT control. Cases such as in the third example occur when a decrease in the insolation caused by a temporal change from daytime to evening, deterioration of weather, etc., decreases output current I_{PV} of the photovoltaic cells 20.

<Holding Mode>

When the power control mode has shifted to the holding mode, the MPPT control unit 115 outputs output voltage V_{PV} at the point in time when it became lower than the halting level of the MPPT control, to the active current control unit 117 via the target voltage switching unit 116 and as target voltage V_{PV*}_{_}_{MPPT}. As illustrated in the portion between points in time t₃ and t₄ in FIG. 5, output voltage V_{PV} of the photovoltaic cells 20 is controlled via the AC invertor 12 so that it becomes equal to target voltage V_{PV*}_{_}_{MPPT}.

As described above, in the control device according to the embodiment, the voltage output from the photovoltaic cells is held as a constant voltage even if the insolation enters a low insolation state during the MPPT control. Therefore, according to the control device of the embodiment, it is possible to continue power generation stably by using photovoltaic cells because the MPPT control being executed does not become unstable even under low insolation such as at sunset, etc.

Next, when output power P_{PV} calculated by the power calculation unit 112 during the holding mode has become further lower so that it has become lower than the operation halting level of the photovoltaic cells 20, the mode switching unit 111 switches the power control mode from the holding mode to the standby mode. The operation halting level of the photovoltaic cells 20 is the lower limit power value that makes the photovoltaic cells 20 halt the generation of power. For example, the mode switching unit 111 instructs the MPPT control unit 115 and the peak voltage holding unit 114 to perform the following operations.

Specifically, when the power control mode has shifted to the standby mode, the MPPT control unit 115 halts the operation of the AC invertor 12. In addition, the peak voltage holding unit 114 resets target voltage VPV*__{^{GPEAK}} held by itself to the lower limit value of the MPPT control, and also resets output power P_{PV} held by itself to the operation starting level of the photovoltaic cells 20.

As illustrated in the portions after time t₄ in FIG. 5, when the halting of the operation of the AC invertor 12 makes the output current from the AC invertor 12 zero, output voltage V_{PV} of the photovoltaic cells 20 rises from output voltage V_{PV} in the holding mode to the open circuit voltage. Then, when the insolation decreases sharply because, for example, it has become nighttime, the output voltage V_{PV} of the photovoltaic cells 20 becomes zero.

As is understood from the above explanations, according to the control device of the embodiment, it is possible to control the output power of photovoltaic cells so that the maximum power in accordance with the insolation can be output as much as possible even under low insolation.

Note that the present invention is not limited to the above embodiment, and allows various modifications and changes without departing from the spirit of the present invention. For example, in the above explanations, the control device of the embodiment is used for a photovoltaic power generation system that controls the generated power of photovoltaic cells via an AC invertor. However, the control device of the embodiment may also be used for other generation systems, such as a wind power generation device and a hydraulic power generation device, that control, via an AC invertor, the generated power of the power generation source that varies depending upon the operation points of the voltage, current, etc.

20

What is claimed is:

1. A control device comprising:
a power calculation unit that calculates an output power of a photovoltaic cell in a sweeping mode in which an output voltage of the photovoltaic cells is gradually varied from an open circuit voltage to a lower limit value of an MPPT (Maximum Power Point Tracking) control;
a peak voltage holding unit that holds a peak voltage of the photovoltaic cell, the peak voltage corresponding to a maximum value of the calculated output power; and
a mode switching unit that switches a power control mode for the photovoltaic cell from the sweeping mode to a global peak mode in which an output voltage of the photovoltaic cell is controlled so that the output voltage becomes closer to the held peak voltage, when the maximum value of the output power calculated upon the varying of the output voltage of the photovoltaic cells from the open circuit voltage to the lower limit value of the MPPT control is lower than a starting level of the MPPT control.

2. The control device according to claim 1, wherein
when the maximum value of output power calculated during the varying of the output voltage of the photovoltaic cell from the open circuit voltage to the lower limit value of the MPPT control has become equal to or higher than a starting level of the MPPT control, the mode switching unit switches the power control mode from the sweeping mode to an MPPT mode in which an operation point of the photovoltaic cell is controlled so that the operation point becomes closer to the maximum power of the photovoltaic cell by using a hill climbing method.

3. The control device according to claim 2, wherein
when output power of the photovoltaic cell calculated during the global peak mode has become equal to or higher than the starting level of the MPPT control, the mode switching unit switches the power control mode from the global peak mode to the MPPT mode.

4. The control device according to claim 3, wherein
when output power of the photovoltaic cell calculated during the MPPT mode has become lower than a halting level of the MPPT control, the mode switching unit switches the power control mode from the MPPT mode to a holding mode in which an output voltage of the photovoltaic cell is held so that the output voltage is an output voltage at a point in time when the output power became lower than the halting level of the MPPT control.

5. The control device according to claim 1, wherein
the control device is included in a photovoltaic power conditioning system that includes an AC (Alternating Current) invertor configured to convert the output power of the photovoltaic cell into AC from DC (Direct Current) so as to output the current to a power system.

6. The control device according to claim 2, wherein
the control device is included in a photovoltaic power conditioning system that includes an AC (Alternating Current) invertor configured to convert the output power of the photovoltaic cell into AC from DC (Direct Current) so as to output the current to a power system.

7. The control device according to claim 3, wherein
the control device is included in a photovoltaic power conditioning system that includes an AC (Alternating Current) invertor configured to convert the output power of the photovoltaic cell into AC from DC (Direct Current) so as to output the current to a power system.

8. The control device according to claim 4, wherein
the control device is included in a photovoltaic power conditioning system that includes an AC (Alternating Current) invertor configured to convert the output power of the photovoltaic cell into AC from DC (Direct Current) so as to output the current to a power system.
